(19) United States
(12) Patent Application Publication
(10) Pub. No.: US 2004/0201225 A1
(43) Pub. Date: Oct. 14, 2004

(54) Lever lock

(76) Inventor: Suk Jin Kim, Dalseong-gun (KR)

Correspondence Address: BIRCH STEWART KOLASCH & BIRCH, PO BOX 747, FALLS CHURCH, VA, 22040-0747, US

(21) Appl. No.: 10/410,214

(22) Filed: Apr. 10, 2003

(51) Int. Cl. E05C 1/12

(52) U.S. Cl. 292/165

(57) ABSTRACT

Disclosed herein is a lever lock. The lever lock is configured so that respective spring cams, provided at one of ends of an outdoor-side spindle and an indoor-side spindle, are located inside covers along with rotation springs. This construction secures design flexibility and the reduction of size of plates. The outdoor-side spindle is provided therein with a connection holder and a pawl cam, which are elastically supported by a spring. When a pawl is moved to lock the lever lock, a connection holder, into which a connection of the indoor-side spindle is inserted, is withdrawn, and separated from bosses formed at the outdoor-side spindle, thereby causing an outdoor-side lever to be in an idle state. The spring cam is formed with steps, having a wide radius of rotation, at certain upper and lower positions of the circumference thereof. The steps are adapted to engage with outwardly-extended pieces of a retractor for achieving the bi-directional engagement there between.

### BACKGROUND OF THE INVENTION

1. Field of the Invention

The present invention relates to a lever lock which is configured to simplify the whole construction thereof while satisfying all functions required of a lever lock, and further to open a door even by the rotation of levers within narrow limits.

2. Description of the Related Art

Conventionally, a lever lock requires various functions, for example, a function for preventing the drooping of levers, and a function for causing an outdoor-side lever to be in an idle state to prevent the damage of related components due to the forced rotation of the outdoor-side lever in a locked state, in addition to a basic function for opening a door according to the withdrawal movement of a latch bolt caused by the rotation of either of indoor-side and outdoor-side levers. As an example of a prior art lever lock satisfying such all functions, reference is made in U.S. Pat. No. 5,809,815 and U.S. Pat. No. 5,868,018.

The conventional lever locks for satisfying all the above functions, as described in above patents, however, must have a very complex construction, thereby reducing productivity and hampering the smooth operation thereof.

Due to such a complex construction, rotation springs, as a component of the lever lock for preventing the drooping of levers, are installed in a space defined by plates. This installation structure results an increase in size of the plates, thereby considerably limiting the flexibility of design and the appearance with respect to the plates.

The conventional lever lock is provided with relatively small spindles, which are adapted to be rotated by the levers and to withdraw a retractor using upper and lower protrusions thereof so as to open a door. In this configuration, however, because the upper and lower protrusions have a short radius of rotation, the levers must be rotated over a wide range of about 80° or more in order to withdraw the latch bolt to a desired distance for separating it from a catch. This results in several problems and inconvenience in use.

### SUMMARY OF THE INVENTION

Therefore, the present invention has been made in view of the above problems, and it is an object of the present invention to provide a lever lock, which is configured to simplify the whole construction thereof, thereby achieving an increase in productivity and smooth operation, securing design flexibility and miniaturization with respect to plates and thus generally improving the appearance thereof. It is another object of the present invention to provide a lever lock, which is configured to sufficiently withdraw a retractor in spite of the rotation of levers within narrow ranges (about 60° or less) so as to open a door, thereby increasing the convenience of use thereof with respect to the opening of a door.

In accordance with the present invention, the above and other objects can be accomplished by the provision of a lever lock, which is configured so that an outdoor-side spring cam and an indoor-side spring cam provided, respectively, at one of ends of an outdoor-side spindle and an indoor-side spindle, are located within covers along with respective rotation springs, the outdoor-side spindle being provided therein with a connection holder and a pawl cam elastically supported by a spring, the connection holder being adapted to be disengaged from the outdoor-side spindle as a pawl is moved to withdraw the connection holder, thereby causing the outdoor-side spindle to be in an idle state.

Preferably, the outdoor-side spring cam may be formed with steps, which are adapted to engage with outwardly-extended pieces of a retractor for achieving the bi-directional engagement therebetween, the retractor being adapted to be withdrawn to a distance by the outdoor-side spring cam having a wide radius of rotation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a lever lock according to the present invention;

FIG. 2 is an exploded perspective view illustrating one important portion of the lever lock according to the present invention;

FIG. 3 is an exploded perspective view illustrating the other important portion of the lever lock according to the present invention;

FIG. 4 is a sectional view illustrating the locked state of the lever lock according to the present invention; and

FIG. 5 is a sectional view illustrating the unlocked state of the lever lock according to the present invention.

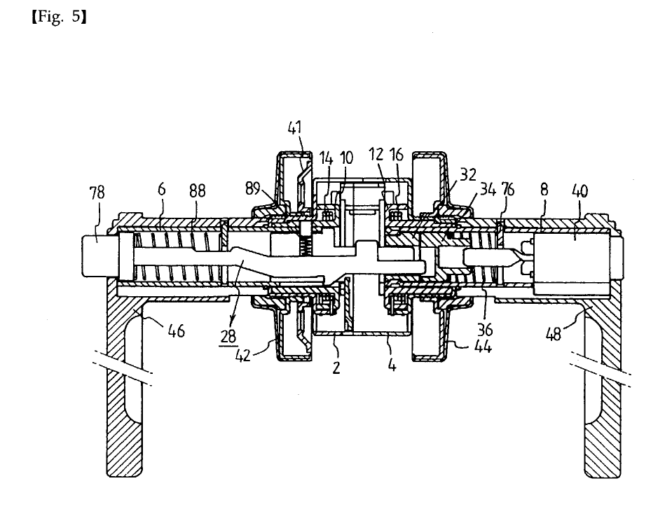

### DESCRIPTION OF THE PREFERRED EMBODIMENTS

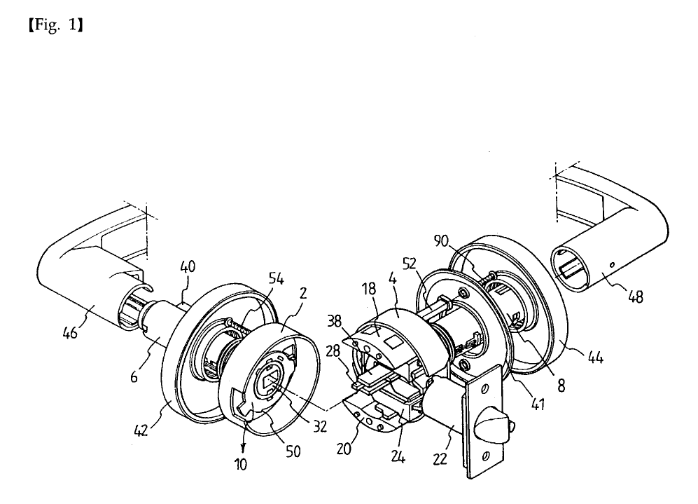

FIG. 1 is an exploded perspective view illustrating a lever lock according to the present invention. As shown in FIG. 1, a lever lock comprises an outdoor-side cover 2 and an indoor-side cover 4, an outdoor-side spindle 6 and an indoor-side spindle 8 rotatably installed, respectively, to the respective covers 2 and 4, an outdoor-side spring cam 10 and an indoor-side spring cam 12 provided, respectively, at one of ends of the respective spindles 6 and 8, and an outdoor-side rotation spring 14 elastically installed between the cover 2 and spring cam 10 and an indoor-side rotation spring 16 elastically installed between the cover 4 and spring cam 12. The lever lock further comprises a retractor 24, a pawl 28, and a pawl stopper 30, a connection holder 32, -a pawl cam 34, a connection 38, and a key assembly 40. The retractor 24 is elastically installed between case holders 18 and 20 by interposing springs 26 while being connected at its front side with a latch bolt 22. The pawl 28 and pawl stopper 30 are adapted to engage with each other, thereby maintaining the locking of the lever lock. The connection holder 32 and the pawl cam 34 are elastically installed, in turn, inside the outdoor-side spindle 6 using a spring 36. The connection 38 is protruded out of the indoor-side spindle 8 so as to be inserted into the connection holder 32 along with the pawl 28. The key assembly 40 is connected to the pawl cam 34 at the side of the outdoor-side spindle 6. Additionally, the outdoor-side cover 2 is provided with an outdoor-side plate 42 and an outdoor-side lever 46, and the indoor-side cover 4 is provided with an indoor-side plate 44 and an indoor-side lever 48. The lever lock constructed as stated above is adapted to be mounted to a door using a door attachment plate 41.

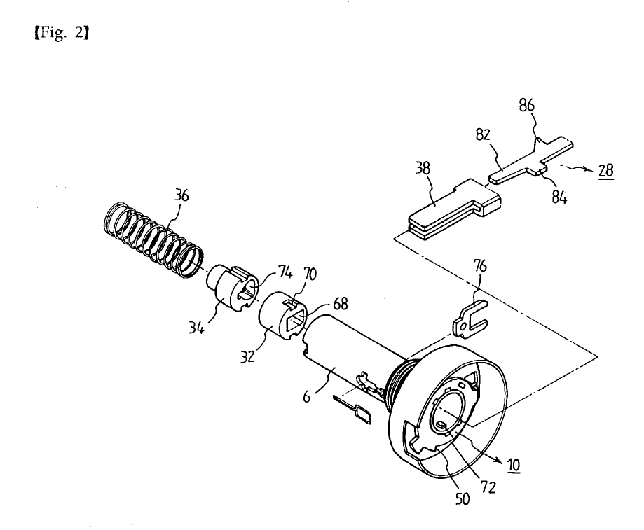

FIG. 2 is an exploded perspective view illustrating one important portion of the lever lock according to the present invention. Referring to FIG. 2, the covers 2 and 4 are formed as left and right separable members, and adapted to receive components therein. The respective covers 2 and 4 are provided with helical portions, respectively, which are used to couple the respective plates 42 and 44.

As described above, the respective spindles 6 and 8 are rotatably fitted into the respective covers 2 and 4, and the spring cams 10 and 12 are provided at the facing inner ends of the respective spindles 6 and 8, thus the spring cams 10 and 12 are adapted to be received inside the covers 2 and 4 along with the rotation springs 14 and 16. Specially, the outdoor-side spring cam 10 is formed with steps 50 at certain upper and lower positions of the circumference thereof so as to be bi-directionally engaged with the retractor 24.

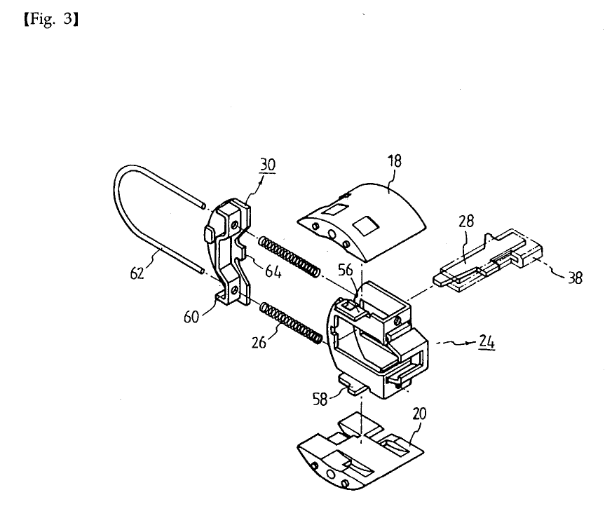

FIG. 3 is an exploded perspective view illustrating the other important portion of the lever lock according to the present invention. The case holders 18 and 20 as shown in FIG. 3 are disposed at the upper and lower sides of a space defined by the outdoor-side cover 2 and indoor-side cover 4, and then integrally coupled with the covers 2 and 4 by fastening a screw nail 54 of the outdoor-side cover 2 into a hollow rod 52 of the outdoor-side cover 4. Before fastening, the screw nail 54 and the hollow rod 52 are extended externally from the covers 2 and 4.

The retractor 24 is formed at the upper and lower side edges with a pair of outwardly-extended pieces 56 and 58, respectively, to bi-directionally engage with the respective spring cams 10 and 12. The retractor 24, connected with the latch bolt 22 at its front side, is slidable in left and right directions between the case holders 18 and 20.

The springs 26, used to elastically support the retractor 24, are fitted through a spring guide pin 62 of a spring guide plate 60 provided at the rear side of the retractor 24. The spring guide plate 60 is integrally formed with the pawl stopper 30 having a center protrusion 64 at its front edge.

The connection holder 32 is formed with a rectangular center penetrating bore 68 for the insertion of the connection 38, and quadrangular recesses 70 formed at the right side edges of the upper and lower surfaces thereof and adapted to receive quadrangular bosses 72 formed at the inner surface of the outdoor-side spindle 6. When the connection holder 32 is completely inserted into the outdoor-side spindle 6, the quadrangular bosses 72 of the outdoor-side spindle 6 are fitted in the quadrangular recesses 70 of the connection holder 32, thereby allowing the connection holder 32 to rotate along with the outdoor-side spindle 6. Then, the connection holder 32 is separated with the bosses 72 according to withdrawal movement thereof. In this state, the outdoor-side spindle 6 and the outdoor-side lever 46 which is associated with it are in an idle state.

The pawl cam 34 is formed at its one side with an eccentric hole 74 and at its the other side with a protruded cylindrical portion for the connection of the key assembly 40. When the pawl cam 34 is inserted in the outdoor-side spindle 6, it is located behind the connection holder 32, and the pawl cam 34 and the connection holder 32 are elastically supported by the spring 36 installed between the pawl cam 34 and a slotter 76.

The pawl 28, installed in the indoor-side spindle 8, comprises a pressing portion 78, a coupling portion 82, a pushing portion 84, and a holding portion 86. The coupling portion 82 is extended at the opposite side of the pressing portion 78 and adapted to be inserted into the eccentric hole 74 of the pawl cam 34 under pushing operation. The pushing portion 84 is protruded beyond the front edge of the connection 38 and adapted to withdraw the connection holder 32. The holding portion 86 is protruded beyond the rear edge of the connection 38 and adapted to engage with the pawl stopper 30. The pawl 28 is elastically supported by springs 88 and 89 disposed at one of lateral sides and the rear side thereof.

The connection 38 is inserted in the connection holder 32 provided inside the outdoor-side spindle 6 while being fixedly connected to the one end of the indoor-side spindle 8, and the pawl 28 slides inside the connection 38.

Now, the structure of the lever lock as stated above will be summarized. The outdoor-side spindle 6 and indoor-side spindle 8, which have the respective spring cams 10 and 12 and the respective rotation springs 14 and 16, are rotatably installed to the covers 2 and 4, respectively. The outdoor-side spindle 6 is successively mounted therein with the connection holder 32 and the pawl cam 34 elastically supported by the spring 36. The retractor 24 coupled with the latch bolt 22 is inserted between the case holders 18 and 20 provided at the upper and lower sides within the covers 2 and 4 while being elastically supported by the springs 26 provided at the rear side thereof. In this state, the pawl stopper 30 is located behind the retractor 24.

After the covers 2 and 4 come up against each other, the screw nail 54 externally extended from the outdoor-side cover 2 is fastened into the hollow rod 52 externally extended from the indoor-side cover 4 in order to fixedly connect the covers 2 and 4 with each other. Also, a screw nail 90 is fastened into the hollow rod 52 through a penetrating hole of the attachment plate 41. Then, the plates 42 and 44 are threadedly coupled through the helical portions of the covers 2 and 4, and the levers 46 and 48 are fixedly coupled to the spindles 6 and 8, respectively.

During assembly, the connection 38, along with the pawl 28, is inserted into the rectangular center penetrating bore 68 formed at the connection holder 32 to complete the connection of the spindles 6 and 8. The steps 50 formed at the outdoor-side spring cam 10 come into contact with the outwardly-extended pieces 56 and 58 of the retractor 24, thereby achieving the bi-directional engagement therebetween. In this state, as the spring cam 10 is rotated using the levers 46 and 48, the retractor 24 is adapted to pull the latch bolt 22 by its withdrawal movement, thereby performing the opening of a door.

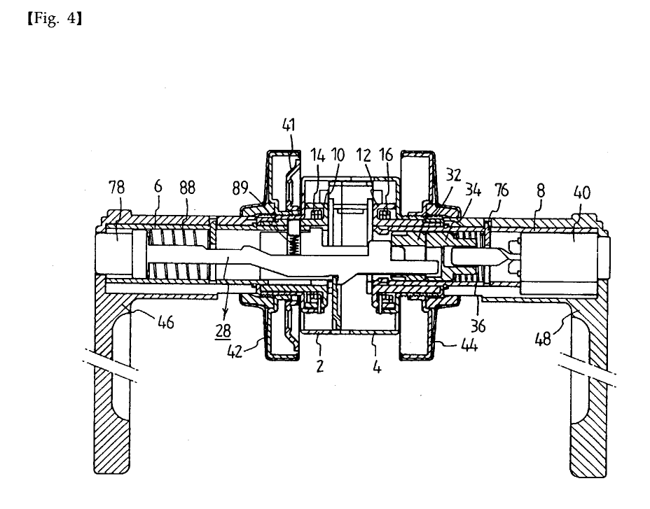

FIG. 4 is a sectional view illustrating the locked state of the lever lock according to the present invention. As shown in FIG. 4, where the pawl 28 is pushed to lock the lever lock, the coupling portion 82 provided at one end of the pawl 28 is protruded far away from the connection 38, and inserted into the eccentric hole 74 of the pawl cam 34. The pushing portion 84 of the pawl 28 withdraws the connection holder 32, thereby causing the bosses 72 formed at the inner surface of the outdoor-side spindle 6 to be separated from the recesses 70. As a result, the outdoor-side spindle 6 is free to rotate. Also, the holding portion 86 behind the pushing portion 84 is engaged with the protrusion 64 of the pawl stopper 30, thereby continuously maintaining the locked state of the lever lock.

In this locked state, as the pawl cam 34 is rotated by the key assembly 40 or the indoor-side lever 48, the coupling portion 82 of the pawl 28 is moved in the opposite direction of the holding portion 86 through the eccentric hole 74 of the pawl cam 34. As a result, the pawl 28 is disengaged from the pawl stopper 30, and returned by the springs 88 and 89 thereof, thereby unlocking the lever lock.

In the resulting unlocked state, the coupling portion 82 of the pawl 28 is separated from the eccentric hole 74 of the pawl cam 23. Then, according the forward movement of the spring 36, the bosses 72 of the outdoor-side spindle 6 are fitted into the recesses 70 provided at the upper and lower sides of the connection holder 32. Thus, the connection holder 32 is integrally rotated along with the outdoor-side spindle 6, resulting in opening the door using the outdoor-side lever 46.

According to the present invention, the lever lock has various advantageous features satisfying all functions required thereof. For example, the spring cam 10 provided at the one end of the spindle 6 is adapted to withdraw the retractor 24, thereby opening a door. Secondly, where the pawl 28 is pushed to lock the lever lock, the outdoor-side lever 46 is in an idle state due to the withdrawal of the connection holder 32. Further, the lever lock is unlocked according to the rotation of the pawl cam 34 caused by the key assembly 40 or the indoor-side lever 48. By virtue of these advantageous features, the whole construction of the lever lock can be considerably simplified.

This simple construction also secures a sufficient inner space of the lever lock, thereby allowing the spring cams 10 and 12 and rotation springs 14 and 16 to be installed in the inner space defined by the covers 2 and 4. As a result, other advantages such as design flexibility and size of the plates 42 and 44 are obtained.

According to the present invention, the spring cams 10 and 12, used to withdraw the retractor 24, are adapted to be rotated over a wide radius of rotation. Namely, the retractor 24 is withdrawn to a distance even by the rotation of the spring cams 10 and 12 within narrow limits, thereby sufficiently pulling the latch bolt 22. As a result, the door can be opened even by the rotation of the levers 46 and 48 within narrow limits.

As apparent from the above description, the present invention provides a lever lock which is configured to simplify the whole construction thereof while satisfying a function for preventing the drooping of levers and a function for causing an outdoor-side lever to be in an idle state in locked state, other than its basic construction, thereby improving productivity and smooth operation thereof.

By virtue of the simple construction, because spring cams and rotation springs, which are adapted to prevent the drooping of the levers, are installed in a space defined by covers, it is possible to freely change the design with respect to the plates and to improve the appearance of the plates due to miniaturization.

According to the present invention, steps formed at spring cams, which are adapted to engage with outwardly-extended pieces of a retractor for achieving the bi-directional engagement therebetween, have a wide radius of rotation. Thus, the retractor can be withdrawn even by the rotation of the levers within narrow limits so as to open a door, thereby increasing convenience in the opening of the door.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A lever lock comprising:
spring cams fixedly connected, respectively, to one of ends of an outdoor-side spindle and an indoor-side spindle rotatably coupled to respective covers, the spring cams being located inside the covers along with rotation springs;
a retractor adapted to be guided inside case holders provided at upper and lower sides of an inner space defined by the covers while being elastically supported by a spring;
a pawl stopper located behind the retractor and adapted to engage with a pawl so as to maintain a locked state;
a connection holder inserted into the outdoor-side spindle so that it is integrally coupled with the outdoor-side spindle or is in an idle state according to the engagement or disengagement with bosses formed at the outdoor-side spindle, the connection holder having a rectangular penetrating bore, into which a connection of the indoor-side spindle is inserted;
a pawl cam coupled behind the connection holder while being elastically supported by a spring along with the connection holder, the pawl cam having an eccentric hole guiding the disengagement of the pawl therethrough; and
the pawl having a coupling portion, a pushing portion, and a holding portion, the coupling portion being inserted into the eccentric hole of the pawl cam when the pawl is moved in the opposite direction of the holding portion, the pushing portion being adapted to withdraw the connection holder to allow it to be separated from the bosses, the holding portion being adapted to engage with the pawl stopper to maintain the locked state.

2. The lever lock as set forth in claim 1, wherein the spring cams are provided with steps at upper and lower positions of a circumference thereof, which are adapted to bi-directionally engage with outwardly-extended pieces formed at upper and lower side edges of the retractor.
